(19) United States
(12) Patent Application Publication
(10) Pub. No.: US 2006/0230319 A1
(43) Pub. Date: Oct. 12, 2006

(54) Automated migration of software instructions

(76) Inventors: Jogarao M. Ryali, Fremont, CA (US); Ramakrishna K. Reddy, Pleasanton, CA (US); Harish K. Rao, Hyderabad (IN); Ram M. Ganti, Hyderabad (IN); Anil A. Iyengar, Secunderabad (IN)

Correspondence Address: VIERRA MAGEN MARCUS & DENIRO LLP, 575 MARKET STREET SUITE 2500, SAN FRANCISCO, CA, 94105, US

(21) Appl. No.: 11/104,355

(22) Filed: Apr. 12, 2005

(51) Int. Cl. G06F 11/00

(52) U.S. Cl. 714/38

(57) ABSTRACT

A system is disclosed for converting a source software script from one format into a target software script having another format. The process includes for converting both a script file for testing a software application as well as GUI files related to a user interface of the software application to be tested. The conversion can be performed automatically, or in a partially automatic fashion. If less than the entire software script is converted, corrections to the target script can be performed automatically

### BACKGROUND OF THE INVENTION

1. Field of the Invention

The present invention is directed to scripts for testing software.

2. Description of the Related Art

Software applications require extensive testing during development and manufacturing. Software application tests can be performed by a software testing application that executes a script in order to interact with the software application being tested. A script is a program or sequence of instructions that is interpreted or carried out by another application program. In the case of software testing, a software test application executes a software test script to test a particular application. The software test application may record, store and repeat user actions, provide input, submit requests, retrieve output and perform other functions based on instructions in the script. Software developers spend a great deal of time generating extensive software test scripts to test software applications.

In addition to software developers, software consumers may also generate software test scripts. For example, a software consumer may modify a software application. In order to ensure the modified application operates properly, software consumers will generate a customized software test script that is tailored to the modified application. For example, after purchasing an invoice processing software application, a business may modify the application to enable the software to track the business inventory flow, provide for additional invoice fields, and other modifications. The business will need to test the invoice software having the modifications in place, and usually does so using software test scripts in combination with a software testing application. These custom software test scripts are extensive and require a significant effort to generate.

Typically, software test scripts have a format, which may be read and processed by a particular software testing application. Many software testing applications exist for processing software test scripts. One example of a software testing application is WinRunner, by Mercury Interactive of Mountain View, Calif. WinRunner executes software test scripts in test scripting language (TSL) that run in the Windows operating system. The Windows operating system is provided by Microsoft Corporation, of Redmond, Wash. Another software testing application is QuickTest Professional (QTP), also by Mercury Interactive. QTP executes scripts in Visual Basic Script (VBS) format to test applications that run in the Windows operating system as well. Other software test applications include Rationale Suite Test Studio and Rational Robot, both of International Business Machines (IBM), Incorporated, of Armonk, New York, and Silk Test, by Segue Corporation, of Lexington, Mass. Each of these software testing applications executes scripts in a different format to test software applications.

As software applications that require testing become more sophisticated, the software testing applications become more sophisticated as well. Software test scripts compatible with one software test application are often not compatible with other software testing applications. For example, QTP is a more recent and sophisticated software testing application than WinRunner, but does not recognize the TSL format testing scripts utilized by WinRunner. Since most companies have invested a large amount of resources in their software testing scripts, migration or conversion of the test scripts is a preferable solution to generating new software test scripts in a new, unfamiliar format.

Several challenges exist in converting one type of software test script to another. For example, in the migration of software test scripts from WinRunner compatible format to QTP compatible format, an in-depth understanding is needed for both WinRunner and QTP functionality. For example, WinRunner software test scripts in TSL format must be converted to QTP software test scripts in VBS format.

In addition to the script file itself, user interface objects of software applications having a graphical user interface (GUI) require additional processing. The GUI Map file objects must be converted to the particular format associated with the new script and/or script executing software.

In some cases, mapping or conversion from a source script to a target script can not be complete. This may be due to differences in the script formats, syntax differences, incomplete libraries, or other reasons. The resulting incomplete conversion often results in improper or failed execution of the script. The incomplete conversion of a source script then needs to be changed and/or corrected.

### SUMMARY OF THE INVENTION

The technology herein, roughly described, pertains to conversion of software test scripts from a first format to another format. In one embodiment, a method for converting a script begins with accessing a source software script in a first format. The source software script is parsed. A target software script in a second format is then generated in response to the parsing. The source software script is for controlling the operation of a first software application and the target software script is for controlling the operation of a second software application. In one embodiment, the first software application and second software application may be used to test a software application under test.

In one embodiment, a method for processing a script includes receiving target script processing information associated with a target script. The target script can be executed by a first script execution engine. A processing script is generated in response to the target script processing information. The generated processing script can be executed by a second script execution engine and contains processing instructions to enable the second script execution engine to cause the first script execution engine to change the target script.

In one embodiment, a method for processing GUI mapping objects includes accessing one or more GUI mapping objects. A hierarchy format is determined to associate with the GUI mapping objects. An object repository tree is generated that includes the mapping objects in the hierarchical format.

One embodiment of a system for converting a set of instructions from one format to another includes a parsing module and a script generation engine. The parsing module receives a set of source software instructions having a first format and parses the received instructions. The script generation engine generates a set of target software instructions in a second format in response to the parsing of the set of source software instructions. The set of target software instructions may comprise a target script.

One or more processor readable storage devices are disclosed which have processor readable code embodied on them. The processor readable code can be used to program one or more processors to perform a method that includes accessing and parsing a source script in a first format. A GUI mapping file associated with the source software script is also parsed. A target script, in a second format, is generated in response to the parsing.

### BRIEF DESCRIPTION OF THE DRAWINGS

FIG. 1 illustrates an embodiment of a software script conversion system.

FIG. 2 illustrates an example of a computer system for implementing the present invention.

FIG. 3 illustrates an embodiment of a method for performing conversion of a software script.

FIG. 4A illustrates an embodiment of a method for performing pre-conversation configuration.

FIG. 4B illustrates an example of an interface for performing pre-conversion configuration.

FIG. 4C illustrates an example of an object repository tree.

FIG. 4D illustrates another example of an object repository tree.

FIG. 5 illustrates an embodiment of a method for converting a script.

FIG. 6 illustrates an embodiment of a method for converting an object repository tree.

FIG. 7A illustrates an embodiment of a method for tracing nodes in an object repository tree.

FIG. 7B illustrates an example of GUI object map.

FIG. 7C illustrates another example of a GUI object map.

FIG. 8 illustrates an embodiment of a method for migrating a source script.

FIG. 9A illustrates an embodiment of a method for converting a line in a source script file.

FIG. 9B illustrates an embodiment of a method for determining if a finction is defined.

FIG. 10 illustrates a method for performing post-migrating script configuration.

FIG. 11A illustrates an embodiment of a system for automatically correcting errors in a target script.

FIG. 11B illustrates an embodiment of a method for automatically correcting errors in a target script.

FIG. 12 illustrates a method for generating a correction script.

### DETAILED DESCRIPTION

Methods and systems are disclosed herein for converting a source software script in one format into a target software script in another format. In one embodiment, the conversion provides for converting both a script file for testing a software application as well as GUI files related to a user interface of the software application to be tested. In one embodiment, all or part of the conversion process is performed automatically. If less than the entire software script can be converted, corrections to the target script are performed automatically.

In one embodiment, the process of converting a script from one format to another begins with confirming the proper execution of the source script. This ensures that any failure during execution of the generated target script is not due to a flawed source script. Pre-conversion configuration is then performed on the source script. Pre-configuration may include processing GUI files associated with the source script and/or software application to be tested. After pre-configuration, the actual conversion of the source script is performed. The conversion of the script may utilize one or more parsers, libraries of functions, objects, properties and constructs, and maps of GUI files, and script generation engine(s).

Post-migration configuration may also be performed, including script compiling, error correction, and other tasks. In some cases, a portion of the source script may not successfully convert into the target script. This may be due to format differences, object mapping issues, or other problems. In any case, error correction may include corrections to the target script performed manually by a user or automatically. When performed automatically, a correction script may be generated that corrects errors in the target script. In some embodiments, the correction script is generated in a format compatible with a software test application other than the test application used to execute the target script. This allows a software test application of one format to direct the software test application associated with the target script to correct errors in the target script. For example, a source script in TSL and compatible with WinRunner may be converted, with errors, to a target script in Visual Basic Script (VBS) which is compatible with QTP. A correction script may be automatically generated which enables WinRunner to engage QTP to perform the necessary corrections to the target script. These steps are discussed in more detail below.

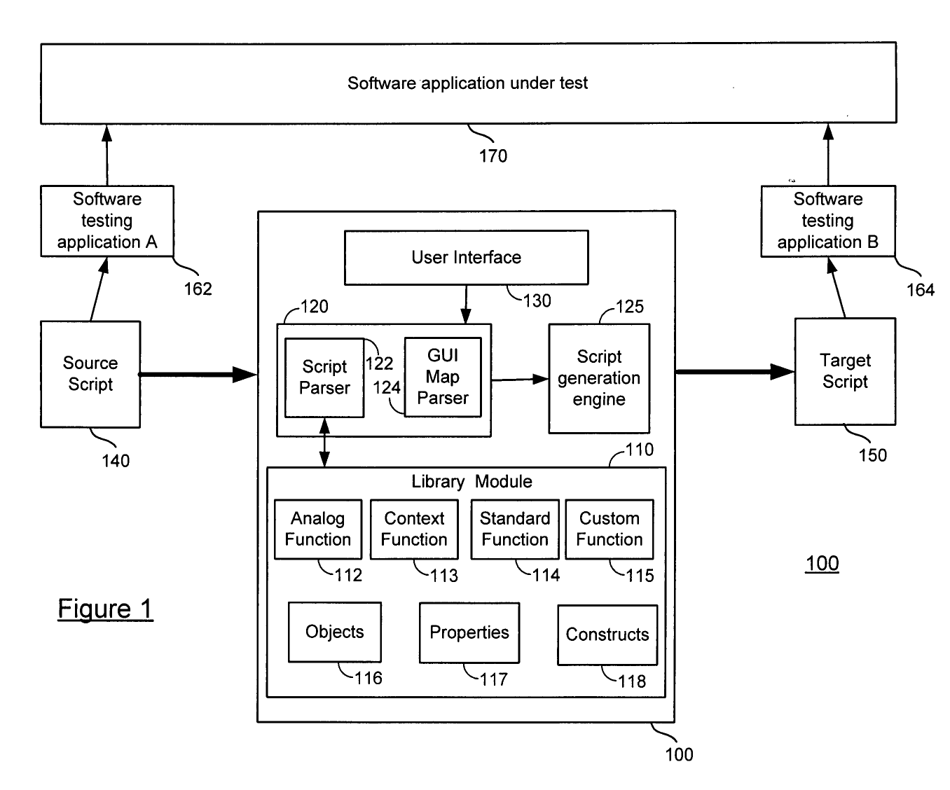

FIG. 1 illustrates an embodiment of one possible script conversion system 100 that can be used to implement the present invention. Script conversion system 100 includes library module 110, parser engine 120, script generation engine 125, and user interface 130. Library module 110 operates to parse functions in received source scripts 140. Library module 110 may include an analog library module 112, context library module 113, standard library module 114, custom library module 115, object library 116, property library 117 and construct library 118. Other library modules may also be used in library modules 110. Operation of library module 110 is discussed in more detail below.

Script conversion system 100 converts source script 140 to target script 150. Source script 140 is in a first format, associated with software testing application A 162. Target script 150 is in a second format associated with software testing application B 164. Software test application A 162 may execute source script 140 to test software application under test 170. Software test application B 164 may execute target script 150 to test software application under test 170. Though both source script 140 and target script 150 are used to test software application under test 170, the scripts have different formats that are recognized by their respective executing software test applications.

Parsing engine 120 includes script parser 122 and GUI map parser 124. Script parser 122 is used to parse source script 140. Source script 140 may include one or more source instructions. In one embodiment, the source instructions are accessed by script parser 122. For each accessed line, script parser 122 detects information such as functions, constructs and other information. The detected information is then sent to library module 110.

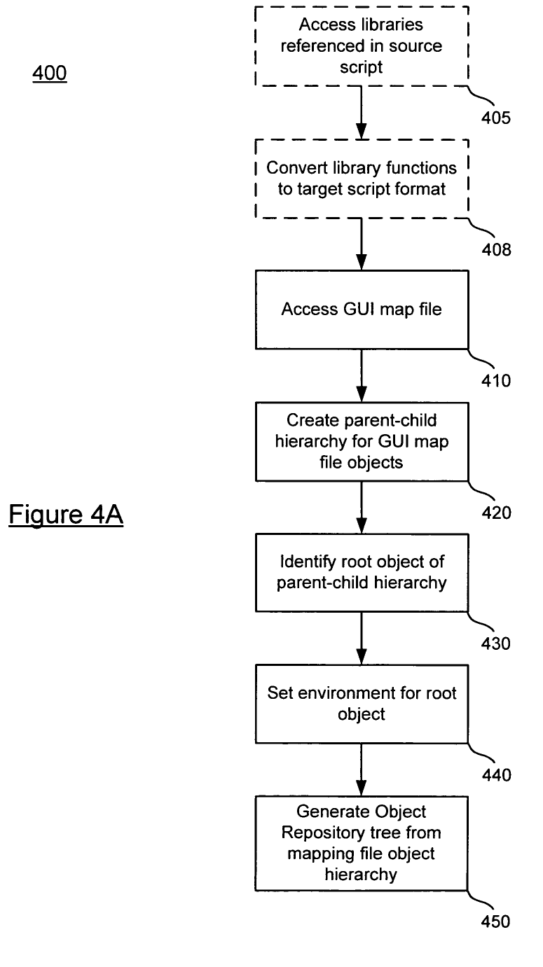

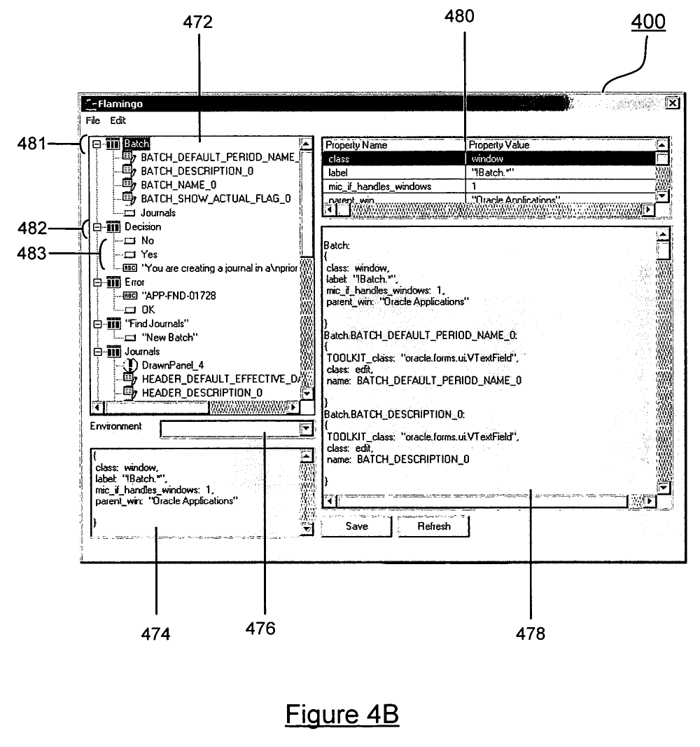

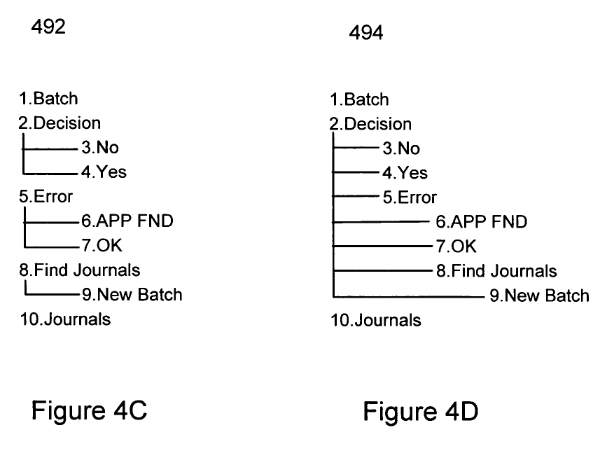

GUI map parser 124 parses GUI map files associated with source script 140. Source scripts will be associated with a GUI map file if the software application the source script is configured to test includes a GUI. In one embodiment, GUI map parser provides a means for generating a parent/child hierarchy between objects in a GUI mapping object file. The objects having the parent/child hierarchy are stored in an object repository (OR) tree. An OR tree is a grouping of GUI objects having an interrelationship that forms a hierarchy. One or more node objects of an OR tree are parent objects to one or more sub-node objects, or child objects. An example of an OR tree is illustrated in more detail in FIG. 4C-4D.

The OR tree is then traced to an OR file in the format of the target script. Additionally, the OR tree may be used to help convert source script functions having hierarchy as defined in the OR tree to corresponding instructions in the target script. Operation of parsing module 120 is discussed in more detail below.

Script generation engine 125 generates target script 150. The generation engine communicates with parsing engine 120 to generate a script that performs the same functions as source script 140, but has a different format. In particular, script generation engine 125 receives instructions from parser engine 120 to insert into a target script file. Operation of script generation engine 125 is discussed in more detail below.

User interface 130 is used to receive input from a user. Input may include selection of target scripts, configuration of a parent/child hierarchy between objects in a GUI mapping object file, and other input. In one embodiment, user interface 130 may be implemented as a GUI, command line or in some other form. Any input device, including a mouse, keyboard, touch screen, or other input device, can be used to interact with user interface 130.

Source script 140 is received by script conversion system 100 and converted into target script 150. In one embodiment, both scripts perform a similar if not identical function, but have different formats. For example, source script 140 may be a software test script in TSL format, compatible with WinRunner. In other embodiments, source script 140 may have a format compatible with some other software testing application, such as Rationale Suite Test Studio and Rational Robot which execute scripts in SQABasic format, Silk Test which execute scripts in object oriented formats, or in other formats such as javaScript, etc.

Target script 150 is a software script file having a different format than that of source script 140. Target script may include one or more target instructions. In one embodiment, target script 150 may be in VBS format, compatible with QTP software test application, or have some other format.

For purposes of discussion, the conversion of a source script in TSL format compatible with WinRunner to a target script in VBS format compatible with QTP will be discussed below. This is for illustrative purposes, and not intended to limit the scope of the invention. It is intended that the present invention may be used to convert to and from other formats.

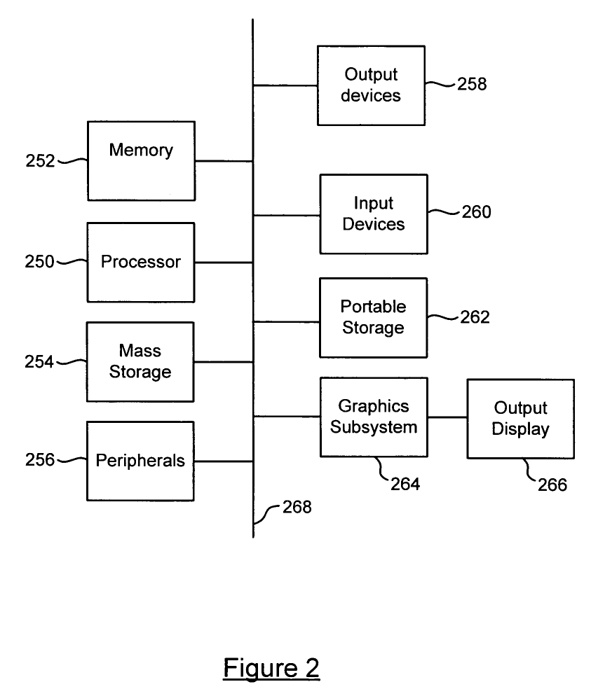

FIG. 2 illustrates high level block diagram of a computer system for which can be used to implement the present invention. Note that other computing systems can also be used. The computer system of FIG. 2 includes one or more processors 250 and main memory 252. Main memory 252 stores, in part, instructions and data for execution by processor unit 250. If the system of the present invention is wholly or partially implemented in software, main memory 252 can store the executable code when in operation. In one embodiment, script conversion system 100 of FIG. 1 is stored within memory 252 of system 200 and executed by one or more processors 250 of system 200. The system of FIG. 2 further includes a mass storage device 254, peripheral device(s) 256, user input device(s) 260, output devices 258, portable storage medium drive(s) 262, a graphics subsystem 264 and an output display 266.

For purposes of simplicity, the components shown in FIG. 2 are depicted as being connected via a single bus 268. However, the components may be connected through one or more data transport means. For example, processor unit 250 and main memory 252 may be connected via a local microprocessor bus, and the mass storage device 254, peripheral device(s) 256, portable storage medium drive(s) 262, and graphics subsystem 264 may be connected via one or more input/output (I/O) buses. Mass storage device 254, which may be implemented with a magnetic disk drive or an optical disk drive, is a non-volatile storage device for storing data and instructions for use by processor unit 250. In one embodiment, mass storage device 254 stores the system software for implementing the present invention for purposes of loading to main memory 252.

Portable storage medium drive 262 operates in conjunction with a portable non-volatile storage medium, such as a floppy disk, to input and output data and code to and from the computer system of FIG. 2. In one embodiment, the system software for implementing the present invention is stored on such a portable medium, and is input to the computer system via the portable storage medium drive 262. Peripheral device(s) 256 may include any type of computer support device, such as an input/output (I/O) interface, to add additional functionality to the computer system. For example, peripheral device(s) 256 may include a network interface for connecting the computer system to a network, a modem, a router, etc.

User input device(s) 260 provides a portion of a user interface. User input device(s) 260 may include an alpha-numeric keypad for inputting alpha-numeric and other information, or a pointing device, such as a mouse, a trackball, stylus, or cursor direction keys. In order to display textual and graphical information, the computer system of FIG. 2 includes graphics subsystem 264 and output display 266. Output display 266 may include a cathode ray tube (CRT) display, liquid crystal display (LCD) or other suitable display device. Graphics subsystem 264 receives textual and graphical information, and processes the information for output to display 266. Additionally, the system of FIG. 2 includes output devices 258. Examples of suitable output devices include speakers, printers, network interfaces, monitors, etc.

The components contained in the computer system of FIG. 2 are those typically found in computer systems suitable for use with the present invention, and are intended to represent a broad category of such computing components that are well known in the art. Thus, the computer system of FIG. 2 can be a personal computer, mobile computing device, handheld computing device, mobile telephone, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

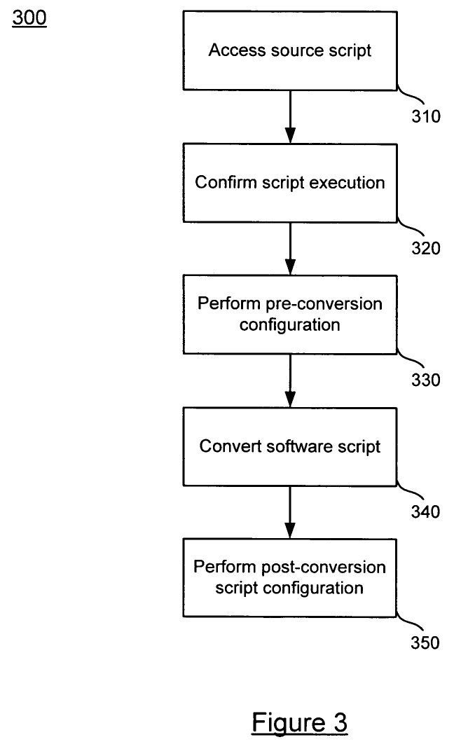

FIG. 3 illustrates an embodiment of a method 300 for migrating a source script having one format to a target script having another format. A source script is accessed at step 310. The accessed source script may be source script 140 of FIG. 1. The source script may be accessed locally or from some remote location over a network.

In one embodiment, the source script is in TSL and is compatible with WinRunner. An example of a portion of a source script in TSL format and compatible with WinRunner is shown below. The TSL format source script below is used to generate an Oracle Purchase Order. In particular, the TSL script loads an Internet browser and an Oracle application, performs login to the Oracle application, performs a responsibility switch, creates the purchase order, saves the purchase order, and closes the Oracle application and Internet browser.

```
**********************************************************************
**** WinRunner Script
**********************************************************************
  waitTime = 10;
web_browser_invoke(IE,“http://mercury.sierraatlantic.com:8300/dev60cgi/f60cgi?play=
&record=names”);
  wait(30);
# Oracle Applications
    set_window(“Oracle Applications - PSONUI-Dev 11i Instance”, 100);
    set_window(“Oracle Applications”);
    wait(5);
    edit_set_focus(“SIGNON_USERNAME_0”);
    edit_set(“SIGNON_USERNAME_0”, “OPERATIONS”);
    wait(5);
    edit_set_focus(“SIGNON_PASSWORD_0”);
    edit_set(“SIGNON_PASSWORD_0”, “WELCOME”);
    wait(5);
    button_press(“Connect”);
# Responsibilities
    if(win_exists(“Responsibilities”, wait_time) == E_OK)
    {
        set_window(“Responsibilities”);
        button_press(“OK”);
    }
# Oracle Applications - PCABO...
    set_window(“Oracle Applications - PSONUI-Dev 11i Instance”, waitTime);
    menu_select_item(“File;Switch Responsibility...”);
    obj_get_info(“Switch Responsibility...”,“enabled”,status);
    # Responsibilities
        set_window(“Responsibilities”, waitTime);
        edit_set_focus(“Find_0”);
        edit_set(“Find_0”, “Purchasing, Vision Operations (USA)”);
        button_press(“Find_2”);
    # Verification for responsibility choice
        set_window(“Oracle Applications - PSONUI-Dev 11i Instance”,
waitTime);
        obj_get_info(“StatusBar[2]”,“value”,status);
        value = substr(status,“0”,“40”);
        if (value == “Choices in list: 0 (Choices in full list”)
        {
            tl_step(“SwitchResponsibility”, FAIL, “Responsibility
”&Responsibility&“ does not exists”);
            odq_set_window(“Responsibilities”, waitTime);
            button_press(“Cancel”);
            texit;
        }
# If switch responsibility window does not exist,
# then there is a possibility that Navigator window already exist
# Verification of Navigator window
    rc = win_exists(“Navigator”, wait time);
    if ( rc == E_OK)
    {
        set_window(“Navigator”);
        obj_get_info(“Title”,“value”,title);
        temp_index = index(title,“-”);
        actualResp = substr(title,temp_index+2);
        res = compare_text(actualResp,Responsibility);
        if(res == 1)
            tl_step(“SwitchResponsibility”, PASS, “Responsibility set to
”&actualResp);
        else
        {
            tl_step(“SwitchResponsibility”, FAIL, “Wrong responsibility”);
            texit;
        }
    }
    else
    {
        tl_step(“SwitchResponsibility”, FAIL, “Navigator window did not come
up”);
        texit;
    }
# Requisitions (Sonus US OU) - [New]
    edit_set(“LINES_QUANTITY_0”, “2”);
    edit_set_focus(“LINES_UNIT_PRICE_0”);
    edit_set(“LINES_UNIT_PRICE_0”, “45”);
# Oracle Applications - PSONUI-Dev 11i Instance
    set_window(“Oracle Applications - PSONUI-Dev 11i Instance”, 2);
    toolbar_button_press(“ToolBar”, “Save”);
  wait( 15 );
# Distributions (Sonus US OU) - [New]
    win_close(“Distributions (Sonus US OU) - [New]”);
    set_window(“Requisitions (Sonus US OU) - [New]”, 1);
    edit_get_text(“PO_REQ_HDR_SEGMENT1_0”,reqno);
    set_window(“Oracle Applications - PSONUI-Dev 11i Instance”, 2);
# Requisitions (Sonus US OU) - [New]
    set_window(“Requisitions (Sonus US OU) - [New]”, 6);
    button_press(“Approve...”);
# Approve Document (Sonus US OU) - 132
    set_window(“Approve Document (Sonus US OU) - 132”, 8);
    button_press(“OK”);
# Note
  rc1 = win_exists(“Note”, 15);
    if ( rc1 == E_OK )
    {
        set_window(“Note”, 3);
        button_press(“OK”);
    }
# Requisitions (CMC North America) - [New]
    win_close(“Requisitions (Sonus US OU) - [New]”);
# Navigator - NA Purchasing Super User
    set_window(“Navigator - Purchasing Super User”, 2);
    button_press(“VButton_6”);
    texit;
```

The source script in TSL format above enables testing of a purchase order software application. The source script includes a function “reqno” that, when executed, causes a software test application to input requisitions to a purchase order software interface. A number of requisitions are defined within the software.

Execution of the source script is confirmed at step 320. In one embodiment, the source script is executed to confirm that it is operating correctly. In a case where the source script is a TSL script, the script may be executed by WinRunner software. If the script does not operate correctly, then information regarding the failed execution is logged by the executing software and operation of method 300 ends.

Pre-conversion configuration is performed at step 330. Pre-conversion configuration may include processing of a source script into a more efficient format for conversion and generating additional files, such as migrated library function files, for use during migration. Pre-conversion configuration is discussed in more detail below in method 400 of FIG. 4A.

Software script conversion is performed at step 340. Script conversion involves generating a target script from a source script. Software script conversion is discussed in more detail below with respect to method 600. Post-conversion script configuration is then performed at step 350. In one embodiment, post-conversion configuration includes checking for errors, allowing for user changes, and corrections of errors. Post-conversion configuration is discussed in more detail below with respect to method 1000.

FIG. 4A illustrates an embodiment of a method 400 for performing pre-conversion configuration as discussed above in step 330 of method 300.

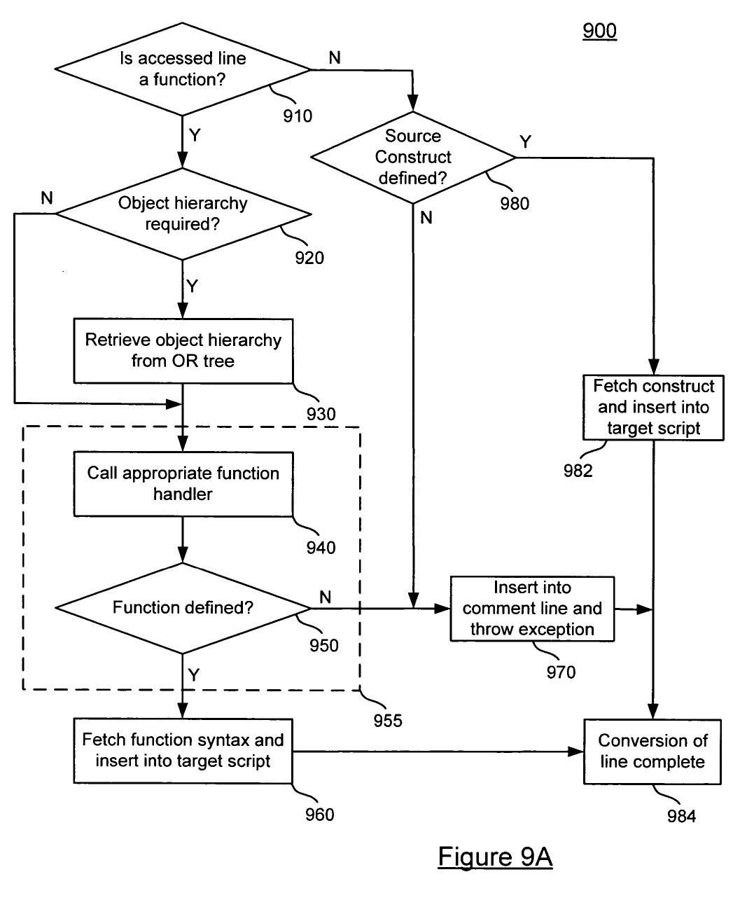

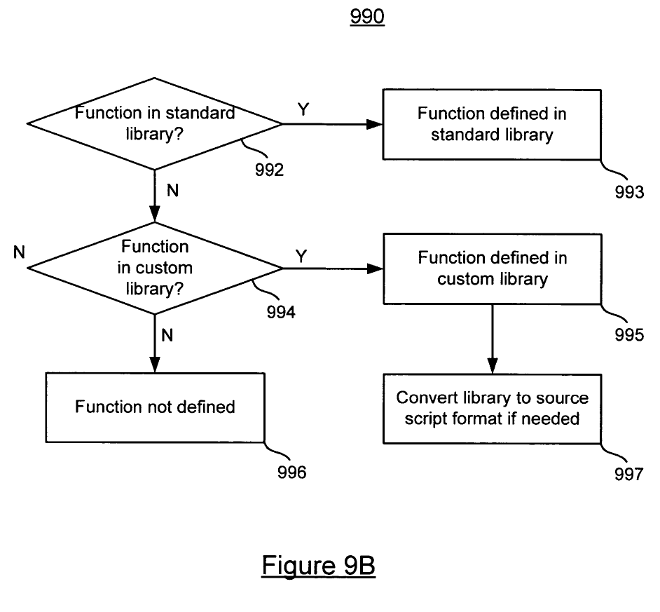

Many scripts make use of libraries. The libraries can be standard libraries for the software tools or custom libraries. Conversion system 100 will be pre-programmed to know how to convert functions of standard libraries be storing a mapping of function calls in a first format to function calls in a second format. When custom libraries are used, conversion system 100 may need to convert the custom libraries from the first format to the second format. Conversion of custom libraries may be performed during pre-conversion configuration or on demand when the functions within the library are needed. When generated on-demand, the libraries may be converted using step 997 of FIG. 9B, discussed in more detail below. Pre-conversion configuration can save time during generation of the target script; however, the pre-conversion (steps 405 and 408) is optional.

Libraries referenced within the source script are accessed at step 405. The accessed libraries are in the format of the source script. The libraries are then converted to the format of the target script at step 408. Conversion to target script format may include changing a library object name, one or more library object parameters, or performing some other action. In one embodiment, conversion of a referenced library is performed similarly to script conversion discussed below.

Pre-conversion configuration may include processing of GUI object mapping files and library files referenced in the source script. As discussed above, a source script may be associated with a GUI object mapping file if the software application to be tested includes a GUI. In one embodiment, GUI object mapping files associated with a source script are referenced within the source script. Thus, GUI mapping object files associated with a source script may be detected by analyzing the source script to look for reference to a GUI or a GUI map.

A GUI map file is accessed at step 410. In one embodiment, the GUI map file contains one or more mapping objects and is associated with a source script. A GUI object mapping file is a list of GUI objects (windows, menus, buttons, lists, etc.) associated with an application and/or an environment (such as an operating system desktop). For each GUI object, the mapping file contains a list of properties that determine the GUI object's behavior and appearance. A software test application can use the GUI properties identified in the GUI mapping file to detect GUI objects in a particular application.

A parent/child hierarchy for the GUI map file objects is created at step 420. Creating a parent/child hierarchy for the GUI map file objects converts the GUI map file from one format to another. In one embodiment, the map file in a format compatible with WinRunner may is converted to a format compatible with QTP. The conversion includes converting a list of objects contained within a GUI mapping file into a hierarchical parent/child format. Thus, objects formerly listed as a list or placed into a node and sub-node format. A user interface for creating the parent/child relationship is discussed in more detail below with respect to FIG. 4B.

The root objects of the generated parent/child hierarchy are identified at step 440. Identification of the root objects is needed for subsequent processing. Next, an environment is set for the root object at step 450. Possible environments may include, but are not limited to, standard, Active X, Java, Oracle, Siebel, and SAP.

FIG. 4B illustrates an example of an interface 470 for performing pre-conversion configuration as discussed above in method 400 of FIG. 4A. In one embodiment, interface 470 is provided by user interface 130 of FIG. 1. Interface 470 includes OR tree window 472, object code window 474, environment selection window 476, static window 478, and object property window 480. Within the OR tree window 472 are a root node 481, an illustrative node 482 and corresponding sub-nodes 483. Creation of a parent/child hierarchy at step 420 can be performed by rearranging the objects illustrated within OR tree window 472. As the objects within OR tree window 472 are rearranged, by drag-and-drop of the objects for example, the corresponding code for an OR tree is automatically generated and displayed in static window 478. Identifying a root object or node as in step 440 may be performed by selecting a node to be identified as a root object within OR tree window 472 and providing input to select the node. For example, in OR tree window 472, the object “batch” is selected as the root node by selecting the “batch” object icon using an input device. Setting an environment for the selected root object as in step 450 can be performed by selecting an environment from environment selection window 476. In one embodiment, one of a number of environments can be selected from a drop-down menu when the environment window is selected with an input device. The code associated with the currently selected object “batch” is displayed in the object code window 474. The properties associated with the currently selected object are displayed in object property window 480.

FIGS. 4C and 4D illustrate examples of a different OR trees 492 and 494, respectively. The OR trees have the same objects, but a different hierarchy. OR tree 492 of FIG. 4C includes nodes comprised of objects 1, 2, 5, 8 and 10. Objects 3 and 4 are sub-nodes of object 2, objects 6 and 7 are sub-nodes of object 5, and object 9 is a sub-node of object 8. Objects 1 and 10 of OR tree 492 have no sub-nodes. In FIG. 4D, OR tree 494 has nodes of objects 1 and 2. Objects 3-5 are sub-nodes of object 2, objects 6-8 are sub-nodes of object 5, and object 9 is a sub-node of object 8. Objects 1 and 10 of OR tree 494 have no nodes.

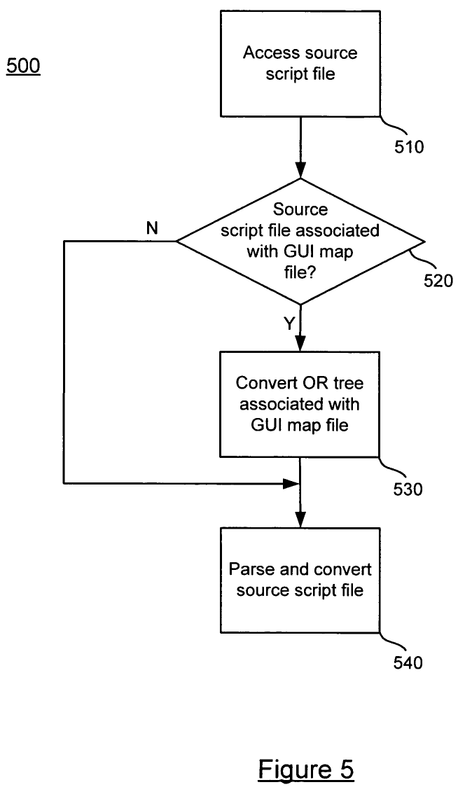

FIG. 5 illustrates an embodiment of a method for performing conversion of a target script as in step 340 of method 300. A source script file is accessed at step 510. A determination is made as to whether the source script file is associated with a GUI map file at step 520. A source script file will be associated with a GUI map file if the application to be tested by the source script file is associated with a GUI. In one embodiment, the source script will reference all GUI object mapping files associated with the source script. In this case, the source script is searched for references to associated GUI object mapping files. If the source script file is associated with a GUI map file, operating continues to step 530. If the source script file is not associated with a GUI map file, operation continues to step 540.

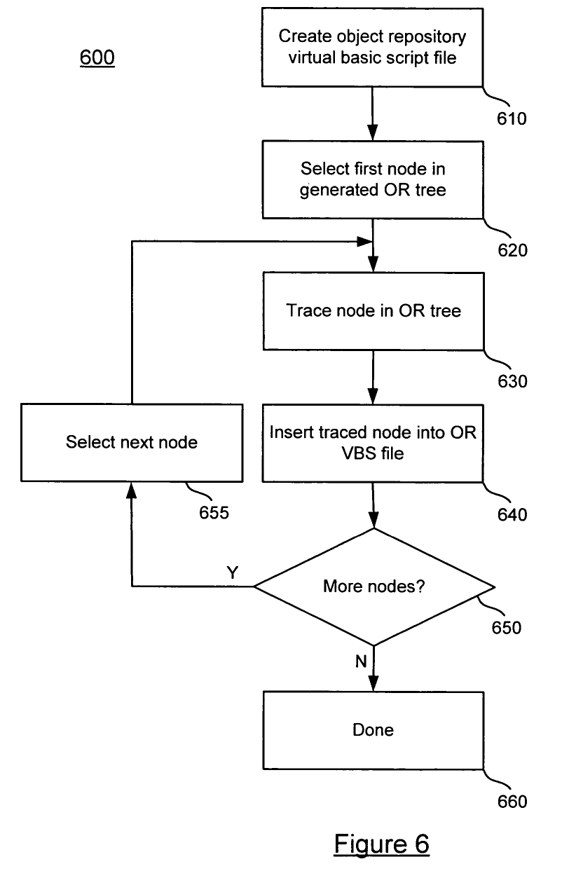

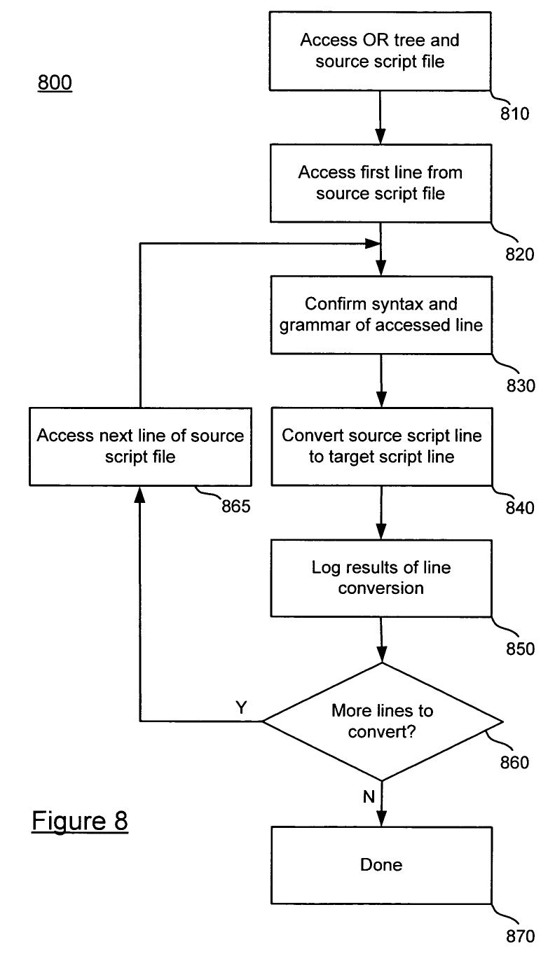

An object repository (OR) tree associated with a GUI map file is converted at step 530. In the case of converting a WinRunner format source script to a QTP format target script, the OR tree is converted to a OR VBS file. Step 530 is discussed in more detail below with respect to method 600 of FIG. 6. Next, the source script file accessed in step 510 is parsed and converted at step 540. The parsing and conversion results in generation of a target script file. Parsing and conversion of a source script to a target script is discussed in more detail below with respect to method 800 of FIG. 8.

FIG. 6 illustrates an embodiment of a method 600 for converting an OR tree associated with a GUI map file as in step 530 of method 500. An OR virtual basic script (VBS) file is created at step 610. The OR VBS file is created to store GUI parameters associated with the target script file. Next, a first root node in the generated OR tree is selected at step 670.

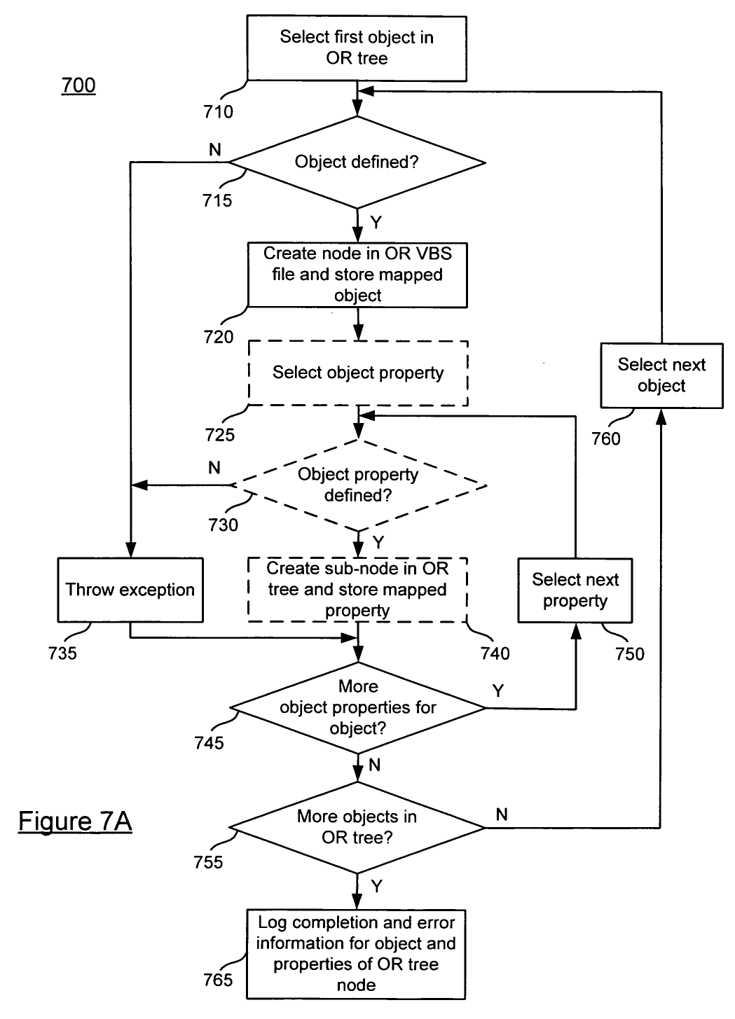

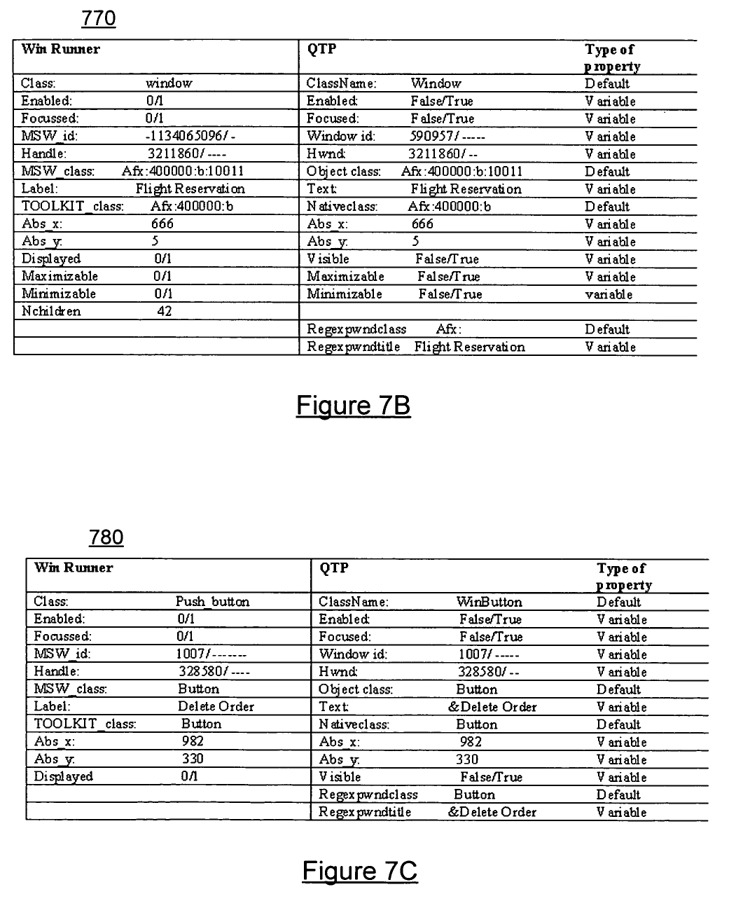

The currently selected node of the OR tree is then traced at step 630. In one embodiment, tracing a node includes capturing the hierarchical relationship between the selected node and all sub-nodes for that node. For example, in FIG. 4C, tracing node 2 of OR tree 492 would capture object 2 and objects 3 and 4 as sub-nodes of node 2. In another example, tracing node 2 of OR tree 494 of FIG. 4D would capture node 2, objects 3-5 as sub-nodes of node 2, objects 6-8 as sub-nodes of sub-node 5, and object 9 as a sub-node of sub-node 8. Tracing an OR tree node is discussed in more detail below with respect to method 700 of FIG. 7.

The traced node is inserted into the OR VBS file at step 640. The traced node will have the same node and sub-nodes as the selected node in the OR tree. Next, a determination is made as to whether more nodes exist to be traced at step 650. If no more nodes exist to be traced within the OR tree, conversion of the OR tree is complete at step 660. If more nodes exist to be traced, then the next node is selected at step 655 and operation continues to step 630 where the next node is traced.

FIG. 7A illustrates an embodiment of a method 700 for tracing a node in an OR tree as in step 630 of method 600. For the embodiment illustrated in method 700, it is assumed that a node is an object and sub-nodes are object properties. In some embodiments, nodes can include objects and sub-nodes may include objects and/or object properties. A first object, or node, in a OR tree is selected at step 710. Next, a determination is made as to whether the selected object is defined at step 715. In one embodiment, an object is defined if it is included in a library of GUI objects accessed by GUI map parser 125, such as object library 116 of FIG. 1. If the object is determined to be defined at step 715, operating continues to step 720. If the object is not defined at step 715, operation continues to step 735. An exception is thrown at step 735. The exception thrown indicates an error has occurred and may provide details of the error (for example, an undefined object was encountered). Operation then continues to step 745.

A node is created in the OR VBS file, and the object mapped at step 710 is stored at that node at step 720. The mapped object is the object in the format of the target script that corresponds to the selected object of the OR tree in the format of the source script. In one embodiment, steps 720-740 of method 700 are only performed if the object includes one or more properties as sub-nodes. An object property associated with the node is selected at step 725. Next, a determination is made as to whether the object property is defined at step 730. Similar to defined objects, a property is defined if it is located within a library of GUI object properties such as property library 117 accessed by GUI map parser 124 of FIG. 1. If the object property selected is not defined at step 730, operation continues to step 735 where an exception is thrown. If the object property is defined, operation continues to step 740.

A sub-node is created in the OR VBS file and the mapped property is then stored in the sub-node at step 740. The mapped property is the property in the format of the target script that corresponds to the selected property of the OR tree in the format of the source script. Next, a determination is made as to whether more properties exist for the object at step 745. If more properties exist for the object, the next property is selected at step 750. Operation then continues to step 730. If no more properties for the object exist, a determination is then made at step 755 whether there are more objects in the particular OR tree node. If the no more objects exist in the OR tree node at step 755, then completion and error information is logged for the objects and properties in the OR tree node at step 765. If more objects exist in the OR tree node, operation continues to step 760 where the next object is selected. Operation then continues to step 715.

FIGS. 7B and 7C illustrates examples of GUI object mapping between WinRunner scripts in TSL and QTP script in VBS. FIGS. 7B and 7C illustrate the QTP object properties that are mapped into an OR VBS file at step 720 of method 700 when the corresponding WinRunner object is encountered in an OR tree. FIG. 7B illustrates a GUI object map 770 for mapping a window object from WinRunner format to QTP format. FIG. 7C illustrates a GUI object map 780 for mapping a push button object from WinRunner format to QTP format.

FIG. 8 illustrates an embodiment of a method for parsing and converting a source script file, as in step 540 of method 500. An OR tree and associated source script file are accessed at step 810. Next, the first line from the source script file is accessed at step 820. The syntax and grammar of the accessed first line is confirmed at step 830. In one embodiment, the syntax and grammar are confirmed to match an expected format and syntax of script instruction in order to ensure for proper recognition and conversion into the format of the target script file. The accessed line is then converted to a line of the target script file at step 840. In one embodiment, conversion is performed on a line-by-line basis for a script file. Line conversion is discussed in more detail below in method 900 of FIG. 9A. The results of the line conversion are logged at step 850.

In one embodiment, several different logs are used to log converted line information. The logs may include an events log, an error log, a debug log, and a summary log. An event log may display overall conversion and analysis report information. The information may include test path selection information, recognized objects in a GUI file for the selected test, successfully mapped objects, statements that were successfully recognized and mapped by a parser, and successfully converted function calls. An error log may include lines not parsed, objects and properties which cannot be converted by the system, and functions which cannot be converted by the system. A debug log may include information for exceptions that occurred during the conversion process and file and function names in which the exceptions occurred. The exception may be thrown during OR tree mapping as discussed with reference to method 700 or during source script line conversion as discussed with respect to method 900. A summary log may include script conversion information as well as GUI conversion information. The script conversion information may include the number of scripts converted, lines successfully parsed, and lines that failed to parse, as well as the function calls recognized, and the function calls mapped. Summary log GUI conversion information may include the number of GUI files, objects recognized and objects successfully converted. In one embodiment, all or some of the logs may be viewable through a user interface, such as user interface 130 of FIG. 1.

Returning to method 800 of FIG. 8, a determination is made as to whether more lines exist to be converted at step 860. In one embodiment, if more lines are in the source script, more lines exist to be converted. If no more lines are to be converted, the conversion process is done at step 870. If more lines exist for conversion, the next line is selected at 865. Operating then continues to step 830.

FIG. 9A illustrates an embodiment of a method 900 for converting a line to a target script file as discussed above at step 840 of method 800. In step 910, a determination is made as to whether the accessed line includes a function. If the accessed line does not include a function, operation continues to step 980. If the accessed line includes a function, then a determination is made as to whether object hierarchy is required at step 920. Object hierarchy may be required if the function calls an object having sub-nodes of other objects or properties. These objects are mapped out in the OR tree. If object hierarchy is not required for line conversion, operation continues to step 940. If object hierarchy is required within the accessed line, the necessary object hierarchy associated with the line is retrieved from the OR tree at step 930.

The appropriate function handler is called at step 940 and a determination is made as to whether the function is defined at step 950. A function is defined if it exists in a standard library or in a custom library that has been converted to the target format. The converter 100 will store a list of functions in the standard libraries and a mapping of the functions to the target format. Step 950 includes examining the list of functions in the standard libraries to see if the function of the current line is listed. If so, then the function is defined. If not, the system checks to see if the function is in a library that is (or will be converted). If so, then the function is defined. Otherwise, the function is not defined. Steps 940 and 950 are discussed in more detail below with respect to method 990 of FIG. 9B.

In one embodiment, the function handlers may include a format handler, analog handler, context handler, standard handler, and custom function handler. Each function handler may be implemented in script parser 122 and be associated with a respective library. The format function handler receives the function in the line having a particular format (for example, STL format for WinRunner) to be converted. The format function handler then accesses a function map to determine the category of the received function. After determining the category, the format function handler delegates the function parsing to the appropriate function handler associated with the determined category.

Each of the analog, context, standard, and custom function handlers are able to look-up a selected functions in their respective function map or library. An analog function handler processes functions related to analog functions and is associated with an analog function library 112. A context function handler processes functions related to context sensitive functions and is associated with a context function library 113. A standard function handler processes standard functions common to many applications and is associated with a standard function library 114. A custom function handler processes user defined or other custom functions and is associated with a custom function library 115. Each library stores a mapping of the function call from the source format to the target format.

If the function is determined to be defined at step 950, the syntax for the function in the target format is fetched from the appropriate library and inserted into the target script at step 960. When converting syntax, the name of the function may change, the parameters may change or other items may change. Conversion of the line is then complete at step 984. If the function is determined not to be defined, the line is inserted into a comment line and an exception is thrown at step 970. A function may be determined as defined if a query for the function to a library returns a converted format for the function. If a query for a function to a library indicates the library does not have the function, the function may be determined to be undefined. In this case, the accessed line will still be included in the target script file. However, since it will be incorporated within a comment line, it will not have any effect within the script file.

If the accessed line is determined not to be a function at step 910, the line is determined to be a construct. A determination is made as to whether or not the source construct is defined at step 980. In one embodiment, a source construct may be considered defined if a query to a construct library returns an associated construct in a desired script format. If the query response indicates the construct is not located in the library, the construct may be determined to be undefined. In one embodiment, queries for constructs may be sent to construct library 118 of FIG. 1. If the source construct is not defined, then the accessed line is inserted into to the target script file within a comment line and an exception is thrown at step 970. If the source construct is defined, then the construct corresponding to the target script format is fetched and inserted into the target script at step 982. Conversion of the line is then complete at step 984. After conversion of a line to a comment line and throwing an exception at step 970, operation continues to step 984.

An example of a portion of a QTP VBS target script which was converted from a WinRunner TSL software test script is shown below. The VBS format source script below generates an Oracle Purchase Order by loading an Internet browser and an Oracle application, performing login to the Oracle application, performing a responsibility switch, creating the purchase order, saving the purchase order, and closing the Oracle application and Internet browser. The VBS script below is generated from, or the result of a migration of, the TSL script above.

```
‘################################################################
‘QTP Script
‘################################################################
    waitTime = 10
    SystemUtil.Run “IEXPLORE.EXE”
    Browser(“Browser”).Navigate
“http://mercury.sierraatlantic.com:8300/dev60cgi/f60cgi?play=&record=names”
    Wait 30
‘ Oracle Applications
    JavaWindow(“Oracle Applications - PSONUI-Dev 11i Instance”).Activate
    JavaWindow(“Oracle Applications - PSONUI-Dev 11i
Instance”).JavaInternalFrame(“Oracle Applications”).Activate
    Wait 5
    JavaWindow(“Oracle Applications - PSONUI-Dev 11i
Instance”).JavaInternalFrame(“Oracle
Applications”).JavaEdit(“SIGNON_USERNAME_0”).SetFocus
    JavaWindow(“Oracle Applications - PSONUI-Dev 11i
Instance”).JavaInternalFrame(“Oracle
Applications”).JavaEdit(“SIGNON_USERNAME_0”).Set “OPERATIONS”
    Wait 5
    JavaWindow(“Oracle Applications - PSONUI-Dev 11i
Instance”).JavaInternalFrame(“Oracle
Applications”).JavaEdit(“SIGNON_PASSWORD_0”).SetFocus
    JavaWindow(“Oracle Applications - PSONUI-Dev 11i
Instance”).JavaInternalFrame(“Oracle
Applications”).JavaEdit(“SIGNON_PASSWORD_0”).Set “WELCOME”
    Wait 5
    JavaWindow(“Oracle Applications - PSONUI-Dev 11i
Instance”).JavaInternalFrame(“Oracle Applications”).JavaButton(“Connect”).Click
‘ Responsibilities
    IF(JavaWindow(“Oracle Applications - PSONUI-Dev 11i
Instance”).JavaInternalFrame(“Responsibilities”).Exist(wait_time)) THEN
        TempVar_IF_0 = E_OK
    ELSE
        TempVar_IF_0 = E_GENERAL_ERROR
    END IF
    IF TempVar_IF_0 = E_OK THEN
        JavaWindow(“Oracle Applications - PSONUI-Dev 11i
Instance”).JavaInternalFrame(“Responsibilities”).Activate
        JavaWindow(“Oracle Applications - PSONUI-Dev 11i
Instance”).JavaInternalFrame(“Responsibilities”).JavaButton(“OK”).Click
‘ Oracle Applications - PCABO...
    END IF
    JavaWindow(“Oracle Applications - PSONUI-Dev 11i Instance”).Activate
    JavaWindow(“Oracle Applications - PSONUI-Dev 11i
Instance”).JavaMenu(“File”).JavaMenu(“Switch Responsibility...”).Select
    status = JavaWindow(“Oracle Applications - PSONUI-Dev 11i
Instance”).JavaMenu(“File”).JavaMenu(“Switch
Responsibility...”).GetROProperty(“Enabled”)
‘ Responsibilities
    JavaWindow(“Oracle Applications - PSONUI-Dev 11i
Instance”).JavaInternalFrame(“Responsibilities”).Activate
    JavaWindow(“Oracle Applications - PSONUI-Dev 11i
Instance”).JavaInternalFrame(“Responsibilities”).JavaEdit(“Find_0”).SetFocus
    JavaWindow(“Oracle Applications - PSONUI-Dev 11i
Instance”).JavaInternalFrame(“Responsibilities”).JavaEdit(“Find_0”).Set “Purchasing,
Vision Operations (USA)”
    JavaWindow(“Oracle Applications - PSONUI-Dev 11i
Instance”).JavaInternalFrame(“Responsibilities”).JavaButton(“Find_2”).Click
‘ Verification for responsibility choice status = JavaWindow(“Oracle Applications
- PSONUI-Dev 11i Instance”).JavaStaticText(“StatusBar[2]”).GetROProperty(“value”)
    value_1 = mid(status,“1”,“40”)
    IF value_1 = “Choices in list: 0 (Choices in full list” THEN
Reporter.ReportEvent micFail,“SwitchResponsibility”,“Responsibility ” &
Responsibility & “ does not exists” JavaWindow(“Oracle Application - PSONUI-Dev
11i Instance”).JavaInternalFrame(“Responsibilities”).Activate
JavaWindow(“Oracle Applications - PSONUI-Dev 11i
Instance”).JavaInternalFrame(“Responsibilities”).JavaButton(“Cancel”).Click
        ExitRun
‘ If switch responsibility window doesnot exist, ‘ then there is a possibility that Navigator
window already exist
‘ Verification of Navigator window END IF
    IF(JavaWindow(“Oracle Applications - PSONUI-Dev 11i
Instance”).JavaInternalFrame(“Navigator”).Exist(wait_time)) THEN rc =
E_OK ELSE  rc = E_GENERAL_ERROR
    END IF
    IF rc = E_OK THEN JavaWindow(“Oracle Applications - PSONUI-Dev 11i
Instance”).JavaInternalFrame(“Navigator”).Activate
title = JavaWindow(“Oracle Applications - PSONUI-Dev 11i
Instance”).JavaInternalFrame(“Navigator”).JavaObject(“Title”).GetROProperty(“value”)
        temp_index = Instr(title,“-”)
        actualResp = mid(title ,temp_index + 2)
        res = StrComp(actualResp , Responsibility)  IF res = 0 THEN
        res = 1 END IF
        IF res = 1 THEN Reporter.ReportEvent
micPass,“SwitchResponsibility”,“Responsibility set to” & actualResp
        ELSE Reporter.ReportEvent micFail,“SwitchResponsibility”,“Wrong
responsibility” ExitRun
        END IF
    ELSE  Reporter.ReportEvent micFail,“SwitchResponsibility”,“Navigator
window did not come up”
        ExitRun
    END IF
‘ Requisitions (Sonus US OU) - [New] JavaWindow(“Oracle Applications -
PSONUI-Dev 11i Instance”).JavaInternalFrame(“Requisitions (Sonus US OU) -
[New]”).JavaEdit(“LINES_QUANTITY_0”).Set “2”
    JavaWindow(“Oracle Applications - PSONUI-Dev 11i
Instance”).JavaInternalFrame(“Requisitions (Sonus US OU) -
[New]”).JavaEdit(“LINES_UNIT_PRICE_0”).SetFocus
    JavaWindow(“Oracle Applications - PSONUI-Dev 11i
Instance”).JavaInternalFrame(“Requisitions (Sonus US OU) -
[New]”).JavaEdit(“LINES_UNIT_PRICE_0”).Set “45”
‘ Oracle Applications - PSONUI-Dev 11i Instance
    JavaWindow(“Oracle Applications - PSONUI-Dev 11i Instance”).Activate
    JavaWindow(“Oracle Applications - PSONUI-Dev 11i
Instance”).JavaToolBar(“ToolBar”).Press “Save”
    Wait 10
‘ Distributions (Sonus US OU) - [New]
    JavaWindow(“Oracle Applications - PSONUI-Dev 11i
Instance”).JavaInternalFrame(“Distributions (Sonus US OU) - [New]”).Close
    JavaWindow(“Oracle Applications - PSONUI-Dev 11i
Instance”).JavaInternalFrame(“Requisitions (Sonus US OU) - [New]”).Activate
    reqno= JavaWindow(“Oracle Applications - PSONUI-Dev 11i
Instance”).JavaInternalFrame(“Requisitions (Sonus US OU) -
[New]”).JavaEdit(“PO_REQ_HDR_SEGMENT1_0”).GetROProperty(“text”)
    JavaWindow(“Oracle Applications - PSONUI-Dev 11i Instance”).Activate
‘Requisitions (Sonus US OU) - [New] JavaWindow(“Oracle Applications -
PSONUI-Dev 11i Instance”).JavaInternalFrame(“Requisitions (Sonus US OU) -
[New]”).Activate
    JavaWindow(“Oracle Applications - PSONUI-Dev 11i
Instance”).JavaInternalFrame(“Requisitions (Sonus US OU) -
[New]”).JavaButton(“Approve...”).Click
‘ Approve Document (Sonus US OU) - 132 JavaWindow(“Oracle Applications -
PSONUI-Dev 11i Instance”).JavaInternalFrame(“Approve Document (Sonus US OU) -
132”).Activate
    JavaWindow(“Oracle Applications - PSONUI-Dev 11i
Instance”).JavaInternalFrame(“Approve Document (Sonus US OU) -
132”).JavaButton(“OK”).Click
‘ Note IF(JavaWindow(“Oracle Applications - PSONUI-Dev 11i
Instance”).JavaInternalFrame(“Note”).Exist(15)) THEN rc1 = E_OK
    ELSE  rc1 = E_GENERAL_ERROREND IF
    IF rc1 = E_OK THEN JavaWindow(“Oracle Applications - PSONUI-Dev 11i
Instance”).JavaInternalFrame(“Note”).Activate
JavaWindow(“Oracle Applications - PSONUI-Dev 11i
Instance”).JavaInternalFrame(“Note”).JavaButton(“OK”).Click
‘Requisitions (CMC North America) - [New] END IF
    JavaWindow(“Oracle Applications - PSONUI-Dev 11i
Instance”).JavaInternalFrame(“Requisitions (Sonus US OU) - [New]”).Close
‘ Navigator - NA Purchasing Super User  JavaWindow(“Oracle Applications -
PSONUI-Dev 11i Instance”).JavaInternalFrame(“Navigator - Purchasing Super
User”).Activate
    JavaWindow(“Oracle Applications - PSONUI-Dev 11i
Instance”).JavaInternalFrame(“Navigator - Purchasing Super
User”).JavaButton(“VButton_6”).Click
    ExitRun
```

FIG. 9B illustrates a method 990 for determining if a function is defined as discussed above with respect to steps 940 and 950 of method 900. A determination is made as to whether the function is in a standard library (also called a native library) at step 992. If the function is in the standard library, operation continues to step 993 wherein the function is determined to be defined. If the function is not in the standard library, a determination is made at step 994 as to whether the function is in a custom library. If the function is found in the custom library, the library is converted to the source script format at step 997, if needed. In one embodiment, conversion of the library of functions can be performed in a similar manner as conversion of a script. If the function is not found in the custom library at step 994, the function is not defined (step 996).

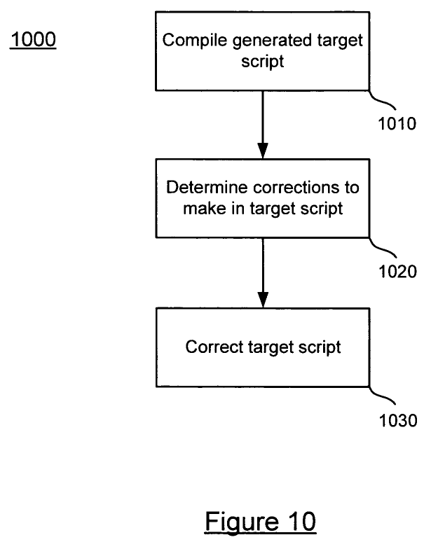

FIG. 10 illustrates an embodiment of a method 1000 for performing post-conversion script configuration as in step 350 of method 300. Compilation of the generated target software script is performed at step 1010. Compilation may be performed by the script compilation software. In one embodiment, this is performed to determine if there are any errors in the generated target script.

Corrections to be made in the target script are determined at step 1020. The needed corrections may be associated with an error in the target script. Errors may be determined from compilation, lines in the source script that were commented out, or otherwise determined from an error log, debug log or some other log. The errors may include duplicate objects, missing statements, parameters or resources, and RunAction settings. These errors are discussed in more detail below. Next, the target software script is corrected at step 1030. This may be done manually or automatically as desired by a user.

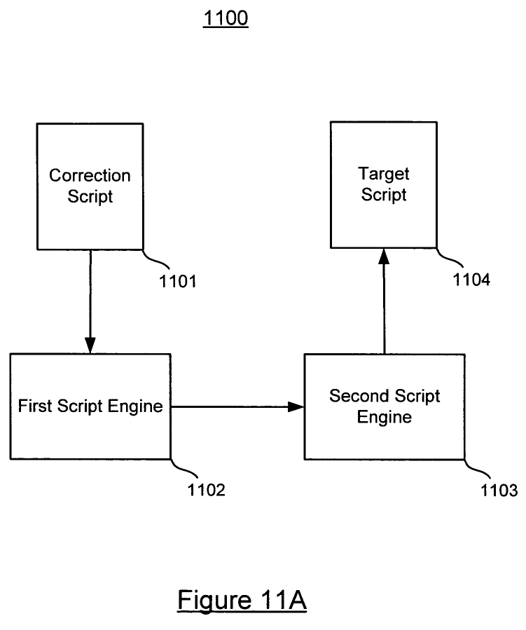

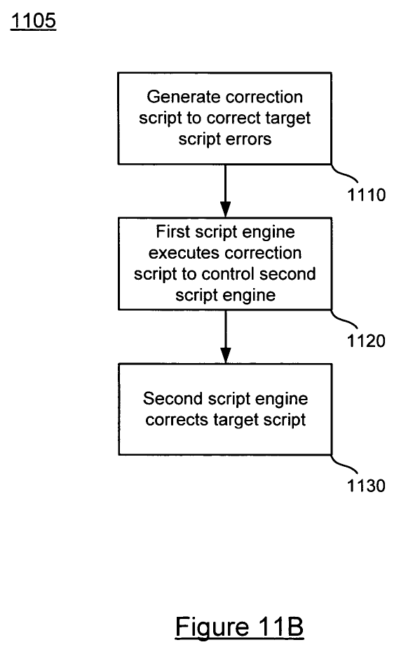

FIG. 11A illustrates a system 1100 for automatically correcting a target script. System 1100 includes correction script 1101, first script engine 1102, second script engine 1103 and target script 1104. Target script 1104 is target script 150 of FIG. 1 and is generated from a source script by a script conversion system such as script conversion system 100 of FIG. 1. In one embodiment, first script engine 1102 and second script engine 1103 may be implemented with software testing application A 162 and software testing application B 164 of FIG. 1, respectively. System 1100 may be used to correct target script 1104 when a script engine used to correct a target script, such as second script engine 1103, is unable to simultaneously execute a correction script and correct or modify a target script.

Correction script 1101 is used to perform corrections to target script 1104. The commands within correction script 1101 cause first script engine 1102 to control second script engine 1103. When first script engine 1102 executes correction script 1101, first script engine 1102 causes second script engine 1103 to correct target script 1104. For example, first script engine 1102 may be implemented using WinRunner and second script engine 1103 may be implemented using QTP. In this case, WinRunner may execute a correction script 1101 in TSL format and cause QTP to correct target script 1104 in VBS format. This is discussed in more detail below with respect to method 1105 of FIG. 11B.

FIG. 11B illustrates an embodiment of a method 1105 for automatically correcting errors in a generated target script file as in step 1030 of method 1000. A correction script is generated to correct the target script errors at step 1110. In one embodiment, the correction script is generated by script generation engine 125 of FIG. 1 from target script processing information such as target script compilation files, information retrieved from parsing the target script, error and other logs generated while creating the target script, and other information. Generation of a correction script is discussed in more detail below. The first script engine executes the correction script to control a second script engine at step 1120. When executed by the first script engine, correction script commands cause the first script engine to provide input to the second script engine. The input is associated with corrections and/or other modifications to be made to target script 1104.

The second script engine corrects the target script at step 1130. The second script engine performs the correction in response to receiving input from the first script engine at step 1120. The input causes the second script engine to access and correct the target script. Examples of corrections that can be made to a target script include inserting actions, configuring parameter and action settings, and adding resources. These and other examples of target script corrections are discussed in more detail below.

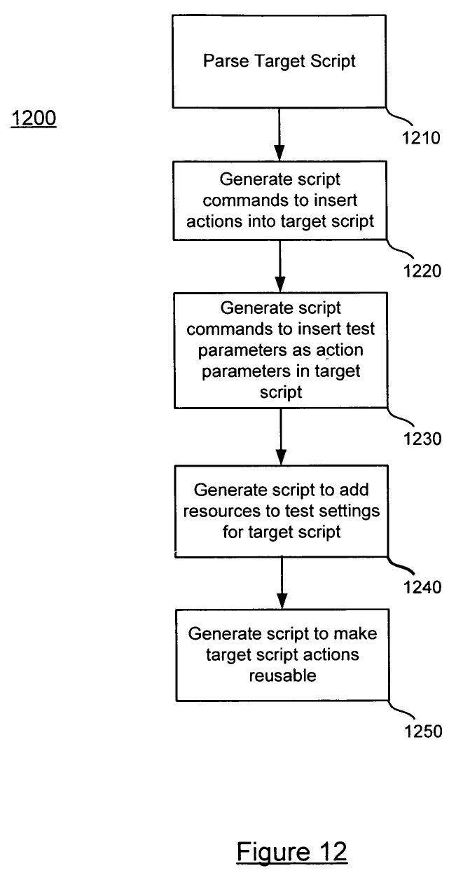

FIG. 12 illustrates a method 1200 for generating a correction script to correct target script errors as in step 1110 of method 1105. A target script is parsed at step 1210. In one embodiment, the script is parsed by script generation software such as script conversion system 100 of FIG. 1. The target script is parsed to determine any errors, duplicate objects, actions, parameters, and resources within the script that may need to be corrected. The correction script is constructed based on the parsed target script information and the source script from which the target script was generated. In one embodiment, steps 1220-1250 for generating script commands in the correction script are performed by script generation engine 125 of FIG. 1.

Commands to insert actions into the target script are generated at step 1220. An action is one or script commands that perform one or more steps. For example, an action of clicking on a mouse button on a web page may consist of a first script command that positions the cursor over the mouse button and a second script command that provides a mouse select input at the selected mouse position. In VBS format, an action may be called within a script (similar to a function). Generation of script commands to insert actions into a target script may include detecting action calls in the target script. Once actions are detected, a current action path for the actions is determined. The action path indicates the location of the action within a file directory. In one embodiment, the current actions path is retrieved from a look-up table. Once the current action path for a called action is determined, the current action path for the detected action is inserted into the target script.

An action may be inserted in a target script to correct duplicate objects detected in the target script. For example, a GUI file associated with a target script may have a window and a push button having the same name of “Bank Accounts”. An action may be inserted in the correction path that renames one of the duplicate object names. In the example, the push button “Bank Accounts” object name may be changed to “Bank_Accounts_pb”. In one embodiment, a look-up table containing a naming scheme for objects and object types may be maintained by script conversion system 100 of FIG. 1. In this case, when duplicate objects are detected during parsing of the target script, an action is generated that changes the name of one of the objects as indicated in the look-up table.

An action may be inserted in a target script to correct syntax errors. Syntax errors may be determined during parsing of compilation of the target script. For example, the label in TSL format “!Payment Documents \\(.*\\).*” may identify an object with the name “Payment Documents (Vision Operations) USA”, but the characters “\\(” are improper syntax to identify a “(38 in VBS format. In this case, the generated action would change the previous label to “!Payment Documents \(.*\).*\”, a label having a syntax in VBS format. In one embodiment, a look-up table containing a syntax conversion scheme from one script format to another is maintained by script conversion system 100 of FIG. 1. When syntax errors are detected during parsing or compilation of the target script, an action is generated that changes the syntax as indicated in the look-up table.

Action path, duplicate object and syntax error correction actions are examples of actions that can be generated and inserted into a correction script at step 1220. These actions are intended only as examples. Other actions in addition to those discussed may be generated and inserted into a correction script as well.

Script commands to insert test parameters as action parameters in the target script are generated at step 1230. In one embodiment, the test parameters are determined while the script is parsed at step 1210. For example, the test parameters may be contained in a comment statement or in configuration statements associated with the command performing the action call. In another embodiment, the test parameters may be derived from the header of the script from which the target script was derived from. In this case, the source script is parsed to derive the test parameters. For example, for target script 150 in FIG. 1, the test parameters may be determined from the header of source script 140. Once the test parameters are determined, a script command is inserted to insert the test parameter as an action parameter in the correction script.

Script commands to add resources to test settings for the target script are generated at step 1240. Adding resources may include updating library files with additional libraries or other resources. In one embodiment, user defined function library files and other types of library files associated with the script engine format that executes the target file can be added. In this case, the target file is parsed by parse engine 124 of FIG. 1, libraries required to execute the target script are identified. Script commands are generated and inserted into the correction script to add any libraries required for target script execution but not already added to the test settings.

Script commands to make target script actions reusable are generated at step 1250. Some script execution engines, such as QTP, may not automatically allow actions to be used, or called, more than one time. Script commands may be generated to configure these script execution engines to allow actions to be used multiple times. The actions may be detected by parsing the target script. Once the actions are determined, script commands can be generated for configuring the particular script execution engine to make each action reusable. In one embodiment, all target script actions may be made reusable. In some embodiments, reusable actions may be determined based on a reusable action list, whether the action is called more than once in the target script, or some other manner.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for converting a script, comprising:
accessing a source software script having a first format, the source software script controls operation of a first software application;
parsing the source software script; and
generating a target software script in response to said parsing, the target software script having a second format, the target software script controls operation of a second software application.

2. The method of claim 1, wherein:
the first software application is a first software testing application and the source software script configures the first software testing application to test a particular software application; and
the second software application is a second software testing application and the target software script configures the second software testing application to test the particular software application.

3. The method of claim 1, further comprising:
performing pre-configuration processing on the source software script.

4. The method of claim 3, wherein said step of performing pre-configuration includes:
formatting a GUI mapping file associated with the software script.

5. The method of claim 3, wherein said step of formatting a GUI mapping file includes:
configuring a hierarchy between GUI mapping file objects within a GUI mapping file.

6. The method of claim 3, further comprising:
generating an object repository tree of mapping file objects

7. The method of claim 4 wherein said step of generating an object repository tree includes setting an environment associated with one or more mapping file objects.

8. The method of claim 1, wherein said step of parsing the source software script includes:
parsing the source script file; and
generating an object repository tree associated with the source script file.

9. The method of claim 8, wherein said step of generating an object repository tree includes:
tracing nodes of an object repository tree having a first format into a second object repository tree having a second format.

10. The method of claim 1, wherein said step of parsing includes:
converting a hierarchy of objects in a source file to a target file.

11. The method of claim 1, wherein the first format is testing script language format.

12. The method of claim 1, wherein the second format is visual basic script format.

13. The method of claim 1, wherein said step of parsing includes:
identifying a source instruction having the first format;
determining whether the instruction is defined; and
generating a target instruction having the second format and corresponding to the identified source instruction.

14. The method of claim 13, wherein the source instruction is a function.

15. The method of claim 14, further comprising:
determining whether the function is associated with hierarchy formatting.

16. The method of claim 14, wherein said step of generating an instruction includes:
selecting a function handler associated with the identified function; and
retrieving a function having the second format and corresponding to the selected function.

17. The method of claim 14, wherein said step of generating the instruction includes:
determining the source instruction is undefined;
generating a target instruction having the second format, the target instruction indicating the source instruction is undefined; and
generating an error in response to said step of determining the source instruction is undefined.

18. A method for processing a script, comprising:
receiving target script processing information associated with a target script, the target script able to be executed by a first script execution engine; and
generating a correction script in response to the target script processing information, the correction script able to be executed by a second script execution engine, the correction script containing processing instructions to enable the second script execution engine to cause the first script execution engine to change the target script.

19. The method of claim 18, further comprising:
compiling the target script, the target script processing information derived from the compiling of the target script.

20. The method of claim 18, wherein the target script processing information includes error information associated with the target script.

21. The method of claim 20, wherein the error information includes information regarding a failed script conversion from a source script to the target script.

22. The method of claim 21, wherein the processing instructions include:
processing instructions to enable the second script execution engine to cause the first script execution engine to correct errors in the target script.

23. The method of claim 18, wherein:
the target script controls operation of a first script execution engine, the correction script controls operation of a second script execution engine,
the first script execution engine is a first software testing application and the target script configures the first software testing application to test a particular software application,
the second script execution engine is a second software testing application and the correction script configures the second software testing application to control the first script execution engine.

24. A method for processing GUI mapping objects, comprising:
accessing one or more GUI mapping objects;
determining a hierarchy format to associate with the GUI mapping objects; and
generating an object repository tree including the mapping objects in the hierarchical format.

25. The method of claim 24, wherein said step of determining the hierarchy format includes:
receiving input from a user selecting the hierarchical format.

26. The method of claim 24, further comprising:
determining an environment for the object repository tree.

27. The method of claim 26, wherein the environment is associated with a root node of the hierarchy format.

28. One or more processor readable storage devices having processor executable modules embodied on said processor readable storage devices, said executable modules including:
a parsing module configured to receive a set of source software instructions having a first format and parse the instructions; and
a script generation engine able to generate a set of target software instructions in a second format in response to the parsing of the set of source software instructions, the set of target software instructions comprising a target script.

29. The one or more processor readable storage devices of system 28, wherein said script generation engine is able to generate a correction script which when executed is configured to cause a second script execution engine to correct errors in the set of target software instructions.

30. The one or more processor readable storage devices of system 28, further comprising:
a GUI map parser able to parse one or more GUI map files associated with the set of source software instructions.

31. The one or more processor readable storage devices of system 30, wherein said GUI map parser is able to generate an object repository tree from the one or more GUI map files.

32. The one or more processor readable storage devices of system 28, wherein the script generation engine is able to generate a target script in VBS format from a source script in TSL format in response to the parsing of the set of source software instructions by said parsing module.

33. The one or more processor readable storage devices of system 28, further comprising:
one or more library modules, the one or more library modules able to provide said script generation engine with a target instruction in response to receiving a source instruction from said parsing module.

34. One or more processor readable storage devices having processor readable code embodied on said processor readable storage devices, said processor readable code for programming one or more processors to perform a method comprising:
accessing a source script having a first format;
parsing the source script;
parsing a GUI mapping file associated with the source script; and
generating a target script in response to said parsing steps, the target script having a second format.

35. The one or more processor readable storage devices according to claim 34, wherein said step of parsing a GUI mapping file includes:
configuring a hierarchy between GUI mapping file objects within a GUI mapping file.

36. The one or more processor readable storage devices according to claim 34, wherein said step of parsing a GUI mapping file includes:
generating an object repository tree of mapping file objects.

37. The one or more processor readable storage devices according to claim 34, wherein the second format is visual basic script.

38. The one or more processor readable storage devices according to claim 34, wherein the first format is test scripting language.

39. The one or more processor readable storage devices according to claim 34, wherein
the source script controls operation of a first software application and the target script controls operation of a second software application,
the first software application is a first software testing application and the source software script configures the first software testing application to test a particular software application,
the second software application is a second software testing application and the target software script configures the second software testing application to test the particular software application.
